(19) United States
(12) Patent Application Publication
(10) Pub. No.: US 2008/0170915 A1
(43) Pub. Date: Jul. 17, 2008

(54) FACE HOBBING OR GEAR CUTTING HEAD FOR CUTTING GEARS, SUCH AS SPIRAL, BEVEL, SPIRAL-BEVEL, AND HYPOID GEARS

(76) Inventor: Dieter Muhlfriedel, Ebermannstadt (DE)

Correspondence Address: KENNAMETAL INC., 1600 TECHNOLOGY WAY, LATROBE, PA, 15650-0231, US

(21) Appl. No.: 12/013,097

(22) Filed: Jan. 11, 2008

Related U.S. Application Data
(63) Continuation-in-part of application No. PCT/EP2006/004646, filed on May 17, 2006.

(30) Foreign Application Priority Data
Jul. 14, 2005 (DE) 10 2005 032 761.3

(51) Int. Cl. B23P 15/34

(52) U.S. Cl. 407/27

(57) ABSTRACT

A face hobbing or gear cutting head for cutting gears, such as spiral, bevel, and hypoid gears which has a blade carrier for holding cutter blades. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

This application is a Continuation-In-Part application of International Patent Application No. PCT/EP2006/004646, filed on May 17, 2006, which claims priority from Federal Republic of Germany Patent Application No. 10 2005 032 761.3, filed on Jul. 14, 2005. International Patent Application No. PCT/EP2006/004646 was pending as of the filing date of this application. The United States was an elected state in International Patent Application No. PCT/EP2006/004646.

### BACKGROUND

1. Technical Field

This application relates to a face hobbing or gear cutting head for cutting gears, such as spiral, bevel, and hypoid gears. This application further relates generally to blade heads and more specifically to a blade head design for indenting spiral bevel gears processing systems and the like.

2. Background Information

Face hobbing machines usually comprise cutting blades arranged about a cutter, not in line with each other, but in groups, usually pairs comprising an inner cutting blade and an outer cutting blade. Unlike most face milling processes, in which all cutting blades pass through the tooth slot during its formation, face hobbing comprises each successive group of cutting blades passing through respective successive tooth slot with each blade in the group forming a cut completely along the longitudinal portion of the tooth slot. The cutter and the workpiece rotate in a timed relationship with each other thereby allowing continual indexing of the workpiece and continual formation of each tooth slot of the gear. A single pair of cutting blades produces a tooth slot.

Certain blade heads are designed for indenting spiral bevel gears used in many types of machinery. For example, one prior art blade head is designed to be mounted on a blade carrier which comprises blade holders whose cross-sectional geometry is composed of a semicircle and a prism. The semicircular cross-sectional geometry serves for holding a bar blade. In the prismatic cross-sectional geometry, a clamping wedge securing the bar blade is inserted. For securing the clamping wedge, clamping screws are, furthermore, provided.

In another prior art design, a blade head which is provided with cylindrical blade holders serving for holding substantially round blade shanks. For securing these round blade shanks, holes are provided in approximately radial direction in the blade head, said holes crossing the blade holders approximately in the area of their tangent. In these holes, pulling or pushing wedges are inserted.

Another form of a blade head uses blades with two flattened sides. The blades are secured in circular blade holders by means of clamping wedges inserted from the front side of the blade head in a direction inclined to the axial direction.

It is a general problem in the art that in all designs, additional clamping wedges are used, which requires a very high constructional expenditure.

### OBJECT OR OBJECTS

Therefore, at least one possible embodiment is based on the task to provide a blade head of the above-mentioned type having a relatively simple construction and a secure seating of the bar blades in the blade holders.

### SUMMARY

A blade head design and method of securing blades within a blade head are provided in which blade holders or receptacles within a blade head are designed complementarily to the blade shanks and have a cross-section in the shape of the segment of a circle so that each bar blade with its blade shank accurately fits into the blade holder.

The above-discussed embodiments of the present invention will be described further hereinbelow. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

A better understanding of at least one embodiment can be obtained when the following detailed description of an exemplary embodiment is considered in conjunction with the following drawings, in which:

FIG. 1 is a perspective view of a blade head comprising a blade carrier and a plurality of bar blades;

FIG. 2 is a top view of the blade carrier according to FIG. 1;

FIG. 3 shows two embodiments of the securing connection of the bar blades by means of two clamping screws each;

FIG. 4 is a top view of a blade holder in the shape of the segment of a circle;

FIG. 5 shows a cross-section of a bar blade, clamped in a blade holder; and

FIG. 6 shows a box diagram of face hobbing or gear cutting head in a gear cutting machine.

### DESCRIPTION OF EMBODIMENT OR EMBODIMENTS

In the figures, parts with the same functions are marked with the same reference or indicia numbers. Further, the terms “blade holder” and “blade holder receptacles” are both used to refer to a method and design for holding a blade in place on a blade head.

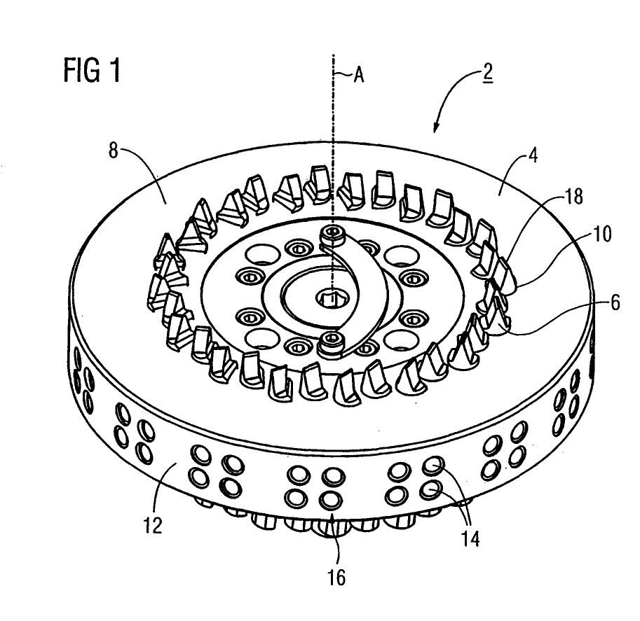

FIG. 1 shows a blade head or gear cutting head 2 comprising a disk-shaped, one-piece blade carrier 4 and a plurality of bar blades or cutter blades 6. The blade carrier 4 is rotatable about a disk rotation axis A. It comprises a machining side 8 with a plurality of blade holders 10, in which the bar blades 6 are held. The disk rotation axis A extends through the center M of the blade carrier 4. The blade holders 10 are arranged in pairs in a circle around the center M of the disk-shaped blade carrier 4. The blade holders 10 are formed by an electric discharge method and have a cross-section in the shape of the segment of a circle. Furthermore, the blade carrier 4 has a peripheral side 12 into which two rows of securing holes 14 are formed, which extend in an approximately radial direction to the disk rotation axis A, the lower row being arranged directly below the upper row, so that columns 16 comprising two securing holes 14 each are formed. The number of columns 16 corresponds to the number of blade holders 10 or bar blades 6. The two securing holes 14 of each column 16 extend in the same direction.

The bar blades 6 are inserted into the blade holders 10. Only the wedge-shaped blade tips 18 protrude over the plane of the machining side 8. The blade shank 20 of each bar blade 6 (see FIG. 3) has a cross-section in the shape of the segment of a circle. Size and shape of the blade shank 20 and the blade holder 10 are adapted to each other in such a way that the blade shank 20 is inserted into the blade holder 10 with accurate fit and abuts the walls of the blade holder 10. The individual bar blades 6 are formed identically to each other.

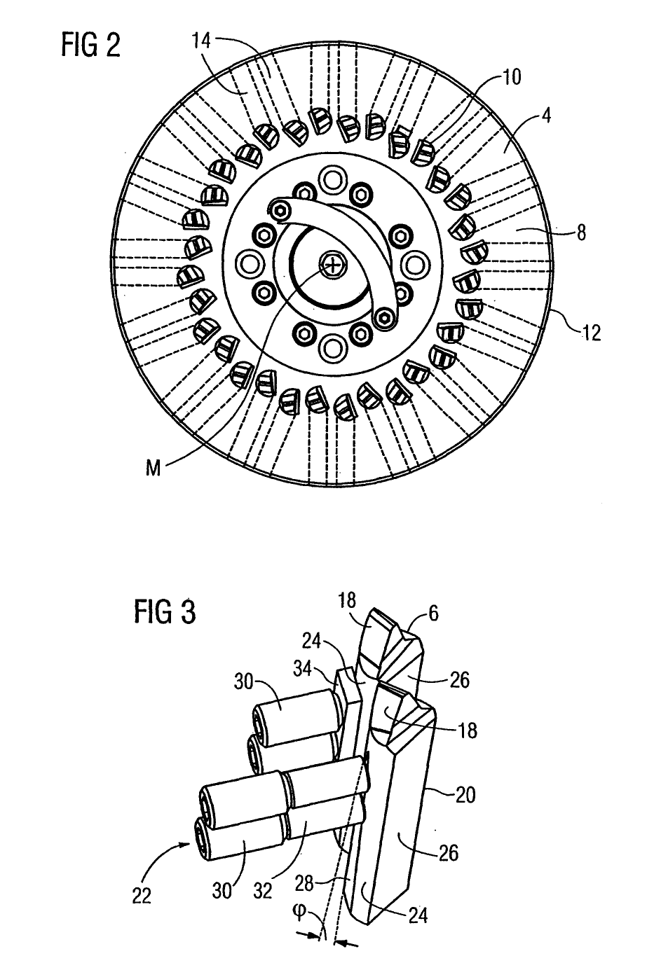

FIG. 2 is a top view of the machining side 8 of the disk-shaped blade carrier 4 according to FIG. 1, in which the projections of the securing holes 14 are shown. A plurality of blade holders 10, each with a cross-section in the shape of the segment of a circle are arranged in a circle around the center M of the blade carrier. All blade holders 10 have the same size and shape, but are in pairs offset and turned to each other, i.e. they have different distances from the center M and include different angles with the radial direction of the disk-shaped blade carrier 4. Two securing holes 14 extend in a substantially radial direction from the peripheral side 12 to each blade holder 10, said securing holes 14 having the shape of channels. Each of the securing holes 14 serves for holding a clamping screw 22 (according to FIG. 3) provided for securing the bar blade 6 inserted into the blade holder 10.

FIG. 3 shows two pairs of clamping screws 22, each of which is pressed against the blade shank 20 of a bar blade 6. The blade shank 20 of each of the bar blades 6 has a cross-section in the shape of the segment of a circle with an angle at center of approximately 255°, so that the blade shank 20 has a rounded side 24 and a flattened side 26. The blade tip 18 is wedge-shaped. The rounded side 24 has a clamping side 28 of flat design which extends over the length of the blade shank 20. The clamping side 28 is inclined towards the longitudinal axis of the bar blade 6 and includes with it an angle φ=1°, so that a wedge effect is achieved and the bar blade 6 cannot slide deeper into the blade holder 10 under axial stress. Through this design, the clamping side 28 tapers in the direction of the blade tip 18, so that it is shaped like a triangle.

On the clamping side 28, contact takes place in each case between a pair of clamping screws 22 and the bar blade 6. Each clamping screw 22 is of a two-piece design and has usually a threaded part 30 and a pin part 32. By means of the threaded part 30, the clamping screw 22 is screwed into the securing hole 14. Then, the clamping screw 22 is tightened in the securing hole 14 until the pin part 32 is pressed against the clamping side 28, so that the clamping screw 22 is clamped against the wall of the blade holder 10. In this case, no joining elements in the form of clamping blocks or clamping wedges, which should transmit the force of the clamping screw 22, are needed, but there is a direct non-positive connection between the clamping screw 22 and the bar blade 6.

Alternatively, the two threaded parts 30 can press the clamping side 28 by means of a common clamping block 34. Unlike the embodiment with two pin parts 32, the force exerted by the clamping screw 22 is transmitted in this case through the common clamping block 34 to the clamping side 28 in a deflection-free manner.

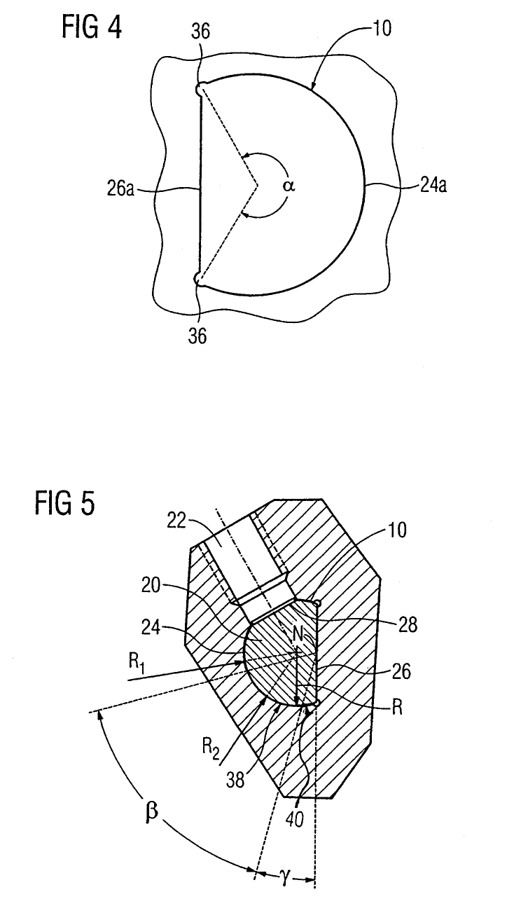

A blade holder 10 in the shape of the segment of a circle with a rounded side 24a and a flattened side 26a is represented in FIG. 4. The rounded side 24a sweeps an angular range with an angle at center a of approximately 255°.

The blade holder 10 constitutes a recess in the disk-shaped blade carrier 4, formed by means of an electric discharge wire-cutting method. With the help of the electric discharge wire-cutting method, all electrically conductive materials can be machined, avoiding the difficulties arising in metal cutting when machining workpieces of high strength. For forming each blade holder 10, first of all two holes 36 are produced in the disk-shaped blade carrier 4, so that the wire can be passed through the disk-shaped blade carrier 4. Starting from the holes 36, a machine accurately cuts out the desired shape by guiding the wire along a specified section.

In the exemplary embodiment according to FIG. 5, the blade shank 20 is inserted into the blade holder 10 and secured by means of the clamping screw 22. The radius R of the rounded side 24 of the blade shank 20 amounts in this exemplary embodiment to 8 mm, whereas the rounded side 24a of the blade holder 10 has a larger radius R₁ of, for example, 8.1 mm. Only in a middle curved section 38, a radius R₂ is provided which corresponds to the radius R and, therefore, amounts to 8 mm in the exemplary embodiment.

Starting from the mid-point N of the flattened side 26, the curved section 38 of the exemplary embodiment has an angle β of approximately 60°. The curved section 38 is positioned in such a way that it is adjoined at its side by another curved section 40, which is adjacent to the flattened side 26a. The additional curved section 40 sweeps—viewed from the mid-point N—an angle γ of approximately 15°.

Due to the radius R₁, enlarged outside the curved section 38 by, for example, approximately 1% as compared with the radius R, the blade shank 20 only abuts the curved section 38.

When the blade shank 20 is secured in the blade holder 10, the clamping screw 22 exerts a force against the clamping side 28 of the blade shank 20. The blade shank 20 is pressed in the direction of this force until its flattened side 26 firmly abuts the corresponding flattened side 26a of the blade holder 10 and part of its rounded side 24 abuts the curved section 38. Therefore, the flattened side 26a of the blade holder 10 and the curved section 38 constitute two basic surfaces upon which the vectorially resolved force of the clamping screw 22 acts, so that the bar blade 6 is clamped fixedly and securely in the blade holder 10 in a defined position.

Therefore, the design according to FIG. 5 specifies, by means of the curved section 38, a defined bearing face for the blade shank 20, defining the radial position of each blade shank 20 in the blade carrier 4. Due to the accurate form of the curved section 38, when the blade holders 10 are inserted into the blade carriers 4, each bar blade 6 is, therefore, adjusted on a specified cutting circle, which is defined by the individual bar blades 6. For a high-quality workpiece machining, the individual cutting corners of the bar blades 6 must lie exactly on a common cutting circle, i.e. in the application of indenting spiral bevel gears, the cutting corners must alternately lie on an inner cutting circle and on an outer cutting circle.

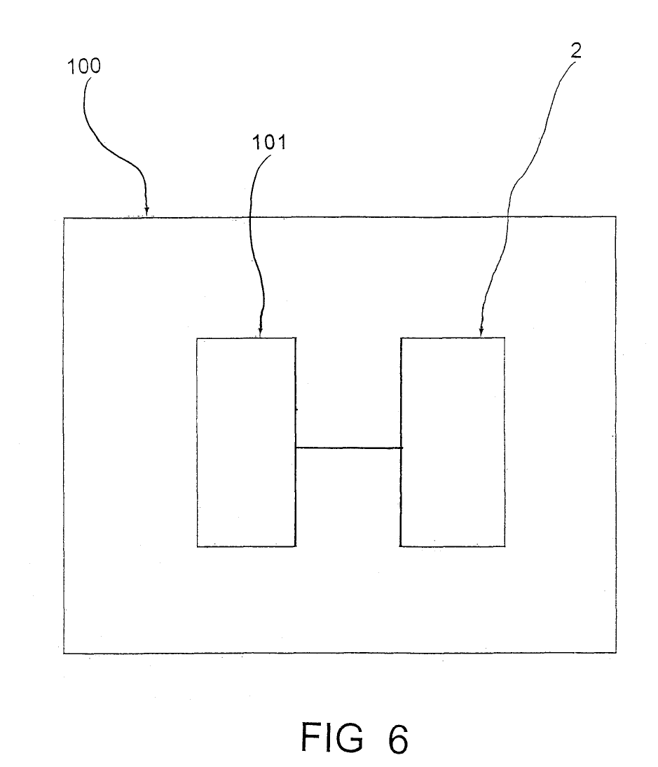

FIG. 6 shows a box diagram of the face hobbing or gear cutting head 2 in a gear cutting machine 100. The gear cutting machine 100 has a rotational drive unit 101 connected to the gear cutting head 2 to drive the gear cutting head 2 in rotation during a cutting operation. Some examples of such gear cutting machines and components thereof that may possibly be utilized or adapted for use in at least one possible embodiment are Oerlikon models C 15, C 28 P, C 40 U, C 60 U, C 100 U, all manufactured by Klingelnberg GmbH, Peterstrasse 45, D-42499 Hueckeswagen.

One feature or aspect of an embodiment is believed at the time of the filing of this patent application to possibly reside broadly in a blade head 2 with a disk-shaped blade carrier 4 comprising a plurality of blade holders 10 and a plurality of bar blades 6 having blade shanks 20, said blade shanks 20 being inserted in the blade holders 10 and said blade shanks 20 having a cross-section in the shape of the segment of a circle, wherein the blade head is characterized in that the blade holders 10, complementarily to the blade shanks 20, have a cross-section in the shape of the segment of a circle, so that each bar blade 6 with its blade shank 20 accurately fits into the blade holder 10.

Another feature or aspect of an embodiment is believed at the time of the filing of this patent application to possibly reside broadly in a blade head characterized in that the cross-section in the shape of the segment of a circle sweeps an angle of >1800.

Yet another feature or aspect of an embodiment is believed at the time of the filing of this patent application to possibly reside broadly in a blade head characterized in that the cross-section in the shape of the segment of a circle sweeps an angle in the range between 220° and 270°.

Still another feature or aspect of an embodiment is believed at the time of the filing of this patent application to possibly reside broadly in a blade head characterized in that the blade holders 10 are formed by an electric discharge method.

Still another feature or aspect of an embodiment is believed at the time of the filing of this patent application to possibly reside broadly in a blade head characterized in that means for securing of each bar blade 6 comprises at least one clamping screw 22 which is screwed into the disk-shaped blade carrier 4 substantially radially to a disk rotation axis A.

Another feature or aspect of an embodiment is believed at the time of the filing of this patent application to possibly reside broadly in a blade head characterized in that each bar blade 6 is secured in the blade holder 10 non-positively exclusively via the clamping screw 22.

A further feature or aspect of an embodiment is believed at the time of the filing of this patent application to possibly reside broadly in a blade head characterized in that the bar blade 6 has a clamping side 28 upon which the clamping screw 22 acts.

Another feature or aspect of an embodiment is believed at the time of the filing of this patent application to possibly reside broadly in a blade head characterized in that the clamping side 28 is inclined to the longitudinal axis of the bar blade 6, including with it an angle φ, which is <5°, or in at least one embodiment is approximately 1°.

Yet another feature or aspect of an embodiment is believed at the time of the filing of this patent application to possibly reside broadly in a blade head characterized in that the cross-section of the bar blades are in the shape of the segment of a circle of the blade holder 10 and include a curved section 38 whose radius R₂ is somewhat smaller than a radius R₁ of the remaining surface in the shape of the segment of a circle.

Still another feature or aspect of an embodiment is believed at the time of the filing of this patent application to possibly reside broadly in a blade head characterized in that the curved section 38 sweeps an angle β between 45° and 90°, or in at least one embodiment an angle in the range of approximately 60°.

A further feature or aspect of an embodiment is believed at the time of the filing of this patent application to possibly reside broadly in a blade head characterized in that the curved section 38 is adjoined at its side by another curved section 40, which is adjacent to a flattened side 26 of the blade holder 10 and sweeps an angle γ between 5° and 30°.

Another feature or aspect of an embodiment is believed at the time of the filing of this patent application to possibly reside broadly in a face hobbing or gear cutting head for cutting gears, such as spiral, bevel, spiral-bevel, or hypoid gears, said cutting head comprising: a disk-shaped body having a top surface and a bottom surface and a side surface extending between the top surface and the bottom surface; a plurality of holding slots extending from the top surface inward into the disk-shaped body; each of said holding slots being configured to receive and hold a cutting blade therein; a plurality of cutting blades each comprising a shank portion and a cutting portion; each of said shank portions having a cross-section being in the shape of the segment of a circle and being inserted into a corresponding holding slot; and said holding slots having a cross-section being in the shape of the segment of a circle and being complementary to said shank portions to permit and promote accurate fit of said shank portions in said holding slots in such a way that said cutting blades are arranged in a defined angular position in a twist-protected manner.

Yet another feature or aspect of an embodiment is believed at the time of the filing of this patent application to possibly reside broadly in a face hobbing or gear cutting head for cutting gears, such as spiral, bevel, spiral-bevel, or hypoid gears, said cutting head comprising: a substantially disk-shaped body having a top surface and a bottom surface and a side surface extending between the top surface and the bottom surface; a plurality of holding slots extending from the top surface inward into the disk-shaped body; each of said holding slots being configured to receive and hold a cutting blade therein; a plurality of cutting blades each comprising a shank portion and a cutting portion; each of said shank portions having a cross-section being in the shape of the segment of a circle and being inserted into a corresponding holding slot; and said holding slots having a cross-section being in the shape of the segment of a circle and being substantially complementary to said shank portions.

Still another feature or aspect of an embodiment is believed at the time of the filing of this patent application to possibly reside broadly in a cutting blade for use in a face hobbing or gear cutting head for cutting gears, such as spiral, bevel, spiral-bevel, or hypoid gears, said cutting blade comprising: a shank portion and a cutting portion; said shank portion having a cross-section having a portion being in the shape of the segment of a circle and being configured to be inserted into a corresponding and substantially complementarily-shaped holding slot in a face hobbing or gear cutting head.

Some examples of face hobbing or gear cutting heads and parts thereof that may possibly be utilized or adapted for use in at least one possible embodiment may possibly be found in the following patent publications, which are incorporated by reference herein: DE 101 12 165 B4; EP 0 813 927 A2; and U.S. Pat. No. 6,632,050 B2.

The components disclosed in the various publications, disclosed or incorporated by reference herein, may possibly be used in possible embodiments of the present invention, as well as equivalents thereof. The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that any or all the examples of patents, published patent applications, and other documents which are included in this application and including those which are referred to in paragraphs which state “Some examples of . . . which may possibly be used in at least one possible embodiment of the present application . . . ” may possibly not be used or useable in any one or more or any embodiments of the application. The sentence immediately above relates to patents, published patent applications and other documents either incorporated by reference or not incorporated by reference.

All of the patents, patent applications or patent publications, which were cited in the International Search Report dated Aug. 23, 2006, and/or cited elsewhere are hereby incorporated by reference as if set forth in their entirety herein as follows: EP0641617; WO9320972; U.S. Pat. No. 6,398,467; and US2003044246.

The corresponding foreign and international patent publication applications, namely, Federal Republic of Germany Patent Application No. 10 2005 032 761.3, filed on Jul. 14, 2005, having inventor Dieter MŨHLFRIEDEL, and DE-OS10 2005 032 761.3 and DE-PS10 2005 032 761.3, and International Application No. PCT/EP2006/004646, filed on May 11, 2006, having WIPO Publication No. WO2007/006361 and inventor Dieter MŨHLFRIEDEL, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):

A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### AT LEAST PARTIAL NOMENCLATURE

2 Blade head
4 Disk-shaped blade carrier
6 Bar blades
8 Machining side
10 Blade holder
12 Peripheral side
14 Securing hole
16 Column
18 Blade tip
20 Blade shank
22 Clamping screw
24 Rounded side of the blade shank
24a Rounded side of the blade holder
26 Flattened side of the blade shank
26a Flattened side of the blade holder
28 Clamping side
30 Threaded part
32 Pin part
34 Clamping block
36 Holes
38 Arc
A Disk rotation axis
M Center
N Mid-point of the flattened side
R, R₁, R₂ Radii
α Angle at center
φ, β, γ Angle

1. A face hobbing or gear cutting head for cutting gears, such as spiral, bevel, spiral-bevel, or hypoid gears, said cutting head comprising:
a disk-shaped body having a top surface and a bottom surface and a side surface extending between the top surface and the bottom surface;
a plurality of holding slots extending from the top surface inward into the disk-shaped body;
each of said holding slots being configured to receive and hold a cutting blade therein;
a plurality of cutting blades each comprising a shank portion and a cutting portion;
each of said shank portions having a cross-section being in the shape of the segment of a circle and being inserted into a corresponding holding slot; and
said holding slots having a cross-section being in the shape of the segment of a circle and being complementary to said shank portions to permit and promote accurate fit of said shank portions in said holding slots in such a way that said cutting blades are arranged in a defined angular position in a twist-protected manner.

2. The face hobbing or gear cutting head according to claim 1, wherein the surface in the shape of the segment of a circle sweeps an angle of >180°.

3. The face hobbing or gear cutting head according to claim 2, wherein the surface in the shape of the segment of a circle sweeps an angle in the range between 220° and 270°.

4. The face hobbing or gear cutting head according to claim 3, wherein:
said face hobbing or gear cutting head further comprises a plurality of clamping screws for securing said cutting blades, at least one for each of said cutting blades; and
each of said clamping screws is screwed into said disk-shaped body substantially radially to an axis of rotation of said disk-shaped body.

5. The face hobbing or gear cutting head according to claim 4, wherein:
each cutting blade is secured in its corresponding holding slot non-positively solely by said at least one clamping screw; and
said cutting blade comprises a clamping surface upon which said clamping screw acts.

6. The face hobbing or gear cutting head according to claim 5, wherein:
said clamping surface is inclined to the longitudinal axis of its cutting blade at an angle of one of: <5° or about 1°; and
each of said holding slots comprises a flattened surface disposed between and to connect the ends of said surface in the shape of the segment of a circle.

7. The face hobbing or gear cutting head according to claim 6, wherein:
the surface in the shape of the segment of a circle of each of said holding slots includes a first curved section, a second curved section, and a third curved section, wherein said second curved section is disposed between and to connect said first and third curved sections; and
said first curved section having a first radius and said second curved section having a second radius, wherein said second radius is somewhat smaller than said first radius.

8. The face hobbing or gear cutting head according to claim 7, wherein:
said second curved section sweeps an angle of one of: between 45° and 90°, and approximately 60°;
said third curved section is disposed adjacent said flattened surface and sweeps an angle between 5° and 30°; and
said holding slots comprise electric-discharge-formed slots.

9. A face hobbing or gear cutting head for cutting gears, such as spiral, bevel, spiral-bevel, or hypoid gears, said cutting head comprising:
a substantially disk-shaped body having a top surface and a bottom surface and a side surface extending between the top surface and the bottom surface;
a plurality of holding slots extending from the top surface inward into the disk-shaped body;
each of said holding slots being configured to receive and hold a cutting blade therein;
a plurality of cutting blades each comprising a shank portion and a cutting portion;
each of said shank portions having a cross-section being in the shape of the segment of a circle and being inserted into a corresponding holding slot; and
said holding slots having a cross-section being in the shape of the segment of a circle and being substantially complementary to said shank portions.

10. The face hobbing or gear cutting head according to claim 9, wherein the surface in the shape of the segment of a circle sweeps an angle of >180°.

11. The face hobbing or gear cutting head according to claim 10, wherein the surface in the shape of the segment of a circle sweeps an angle in the range between 220° and 270°.

12. The face hobbing or gear cutting head according to claim 11, wherein:
said face hobbing or gear cutting head further comprises a plurality of clamping screws for securing said cutting blades, at least one for each of said cutting blades; and
each of said clamping screws is screwed into said disk-shaped body substantially radially to an axis of rotation of said disk-shaped body.

13. The face hobbing or gear cutting head according to claim 12, wherein:
each cutting blade is secured in its corresponding holding slot non-positively solely by said at least one clamping screw; and
said cutting blade comprises a clamping surface upon which said clamping screw acts.

14. The face hobbing or gear cutting head according to claim 13, wherein:
said clamping surface is inclined to the longitudinal axis of its cutting blade at an angle of one of: <5° or about 1°; and
each of said holding slots comprises a flattened surface disposed between and to connect the ends of said surface in the shape of the segment of a circle.

15. The face hobbing or gear cutting head according to claim 14, wherein:
the surface in the shape of the segment of a circle of each of said holding slots includes a first curved section, a second curved section, and a third curved section, wherein said second curved section is disposed between and to connect said first and third curved sections; and
said first curved section having a first radius and said second curved section having a second radius, wherein said second radius is somewhat smaller than said first radius.

16. The face hobbing or gear cutting head according to claim 15, wherein:
said second curved section sweeps an angle of one of: between 45° and 90°, and approximately 60°;
said third curved section is disposed adjacent said flattened surface and sweeps an angle between 5° and 30°; and
said holding slots comprise electric-discharge-formed slots.

17. A face hobbing cutting blade for cutting gears, such as spiral, bevel, spiral-bevel, or hypoid gears, said cutting blade comprising:
a shank portion and a cutting portion;
said shank portion having a cross-section having a portion being in the shape of the segment of a circle and being configured to be inserted into a corresponding and substantially complementarily-shaped holding slot in a face hobbing or gear cutting head.

18. The face hobbing cutting blade according to claim 17, wherein the surface in the shape of the segment of a circle sweeps an angle of >180°.

19. The face hobbing cutting blade according to claim 18, wherein the surface in the shape of the segment of a circle sweeps an angle in the range between 220° and 270°.

20. The face hobbing cutting blade according to claim 19, wherein:
said cutting blade comprises a clamping surface being configured to be engaged by at least one clamping screw to non-positively secure said cutting blade in a corresponding holding slot;
said clamping surface is inclined to the longitudinal axis of its cutting blade at an angle of one of: <5° or about 1°; and
said cutting blade comprises a flattened surface disposed between and to connect the ends of said surface in the shape of the segment of a circle.
